(19) United States
(12) Patent Application Publication
(10) Pub. No.: US 2026/0177958 A1
(43) Pub. Date: Jun. 25, 2026

(54) BELT CONVEYANCE APPARATUS AND FIXING APPARATUS

(71) Applicant: CANON KABUSHIKI KAISHA, Tokyo (JP)

(72) Inventors: TAKAAKI DOSHIDA, Tokyo (JP); TORU MIYAZAWA, Chiba (JP); TAKAYA YAMAZAKI, Chiba (JP)

(21) Appl. No.: 19/423,224

(22) Filed: Dec. 17, 2025

(30) Foreign Application Priority Data
Dec. 24, 2024 (JP) 2024-227295

(51) Int. Cl. G03G 15/20; G03G 15/00

(52) U.S. Cl. CPC G03G 15/2053; G03G 15/206; G03G 15/2064; G03G 15/50; G03G 2215/2009; G03G 2215/2032

(57) ABSTRACT

A belt conveyance apparatus includes an endless belt, a first roller, a second roller, a steering mechanism, a detection unit configured to detect an edge, the detection unit sampling a plurality of points of the edge of the belt during a time period from when the belt starts traveling until the belt, and a control unit configured to control the steering mechanism wherein, during the time period from when the belt starts traveling until the belt rotates one round, the control unit controls the steering mechanism based on a first steering control amount, and wherein, after completion of one rotation of the belt, the control unit controls the steering mechanism based on a second steering control amount larger than the first steering control amount.

### BACKGROUND

### Field of the Technology

The present disclosure relates to a belt conveyance apparatus suitably used for printers, copiers, facsimiles, multifunction peripherals, and other image forming apparatuses, and to a fixing apparatus including the belt conveyance apparatus.

### Description of the Related Art

Image forming apparatuses employing an electrophotographic process and an inkjet recording process use a belt conveyance apparatus including an endless belt supported and stretched by a plurality of tension rollers. The belt is used to, for example, bear and convey a toner image, and convey a recording material to be subjected to image forming. Since the belt is rotatably driven while being supported and stretched by the plurality of tension rollers, a “deviation” of the belt can occur. The “deviation” of the belt refers to a phenomenon in which the rotating belt meanders relative to the tension rollers and deviates toward one side in the width direction. If the belt deviates excessively toward one side, an edge of the one side of the belt comes into contact with other members, possibly causing damage to the belt and other members. Thus, the deviation of the belt is adjusted by belt deviation control in which a sensor unit detects an edge position of the edge of the belt, and one of the plurality of tension rollers (known as a steering roller) is tilted based on the detection result of the sensor unit.

Due to manufacturing tolerances, each belt may have dimensional variations in the width direction. Therefore, in a belt conveyance apparatus, belt positions detected by the sensor unit can vary in one rotation period of the rotating belt because of the dimensional tolerance in belt width. An apparatus described in Japanese Patent Laid-Open No. 2016-109976 uses a method for performing belt deviation control based on pre-generated edge shape data indicating positions over one rotation of the belt. In this control, a reference position mark is provided at one position on the belt. When the belt starts traveling, the belt is rotated one round to allow the mark to be detected by a position sensor. Then, information indicating the belt position in the belt traveling direction currently being detected by the position sensor is matched with positional information indicating belt positions in the traveling direction in the edge shape data, so that the belt position detected by the sensor unit can be corrected based on the edge shape data. Using the edge shape data in this way enables eliminating the dimensional tolerance in belt width in belt positions detected by the sensor unit. Further, an apparatus described in Japanese Patent Laid-Open No. 2014-134577 uses a method for eliminating the dimensional tolerance in belt width by averaging belt positions over one rotation of the belt detected by a sensor unit, and then performing belt deviation control based on the average belt position obtained in the averaging process.

### SUMMARY

According to some embodiments, a belt conveyance apparatus includes a belt in a form of an endless belt, a first roller configured to support and stretch the belt, a second roller configured to support and stretch the belt together with the first roller, a steering mechanism configured to tilt the first roller, which rotates, relative to the second roller, to cause the belt to move reciprocally in a rotational axis direction of the first roller, a detection unit configured to detect an edge of the belt in the rotational axis direction, the detection unit sampling a plurality of points of the edge of the belt during a time period from when the belt starts traveling until the belt rotates one round, and a control unit configured to control the steering mechanism according to a steering control amount obtained by a correction based on the sampling of the edge of the belt detected by the detection unit, wherein, during the time period from when the belt starts traveling until the belt rotates one round, the control unit controls the steering mechanism based on a first steering control amount, and wherein, after completion of one rotation of the belt, the control unit controls the steering mechanism based on a second steering control amount larger than the first steering control amount.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic view illustrating an image forming apparatus.

FIG. 2 is a schematic view illustrating a fixing module.

FIG. 3A is a schematic view illustrating a sensor unit, and FIG. 3B is a cross-sectional view illustrating an optical sensor.

FIG. 4 is a chart illustrating detection characteristics of the optical sensor.

FIG. 5A is a schematic view illustrating a steering mechanism, and FIG. 5B is a schematic view illustrating a part of the steering mechanism.

FIG. 6 is a control block diagram illustrating a control system for belt deviation control.

FIG. 7 is a block diagram illustrating steering motor control.

FIG. 8 is a flowchart illustrating belt deviation control processing.

### DESCRIPTION OF THE EMBODIMENTS

### <Image Forming Apparatus>

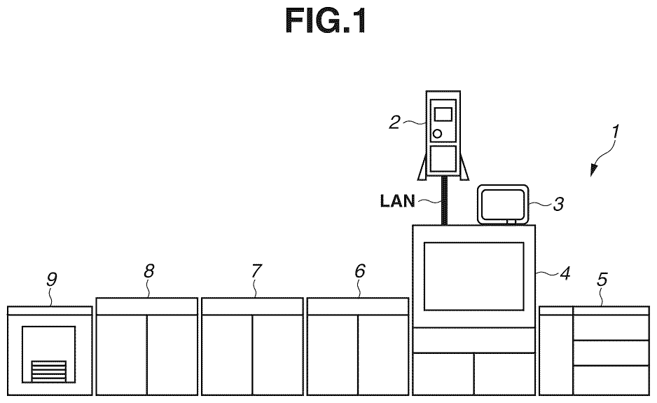

Various exemplary embodiments, features, and aspects of the present disclosure will be described below with reference to the accompanying drawings. FIG. 1 is a schematic view illustrating an image forming apparatus 1 according to the present embodiment. The image forming apparatus 1 illustrated in FIG. 1 is an example of an inkjet recording apparatus of a sheet type for forming an ink image on a recording material by using two different liquids, which are a reaction liquid and inks. The image forming apparatus 1 is connected with an external apparatus 2, such as a personal computer, via an input/output interface, such as a Local Area Network (LAN) to communicate with each other. The image forming apparatus 1 forms an image corresponding to an image signal from the external apparatus 2 on a recording material. The image forming apparatus 1 is provided with an operation unit 3 including a display unit for displaying various information and keys for inputting various information in response to user operations. Via the operation unit 3, a user inputs various instructions, such as instructions for starting and stopping an image forming job and instructions for opening and closing the tray of a sheet feeding module 5. Examples of recording materials include plain paper, thick paper, plastic films (overhead projector (OHP) sheets), special shape sheets (envelopes and index paper), cloths, and other ink-receptive sheet materials.

As illustrated in FIG. 1, the image forming apparatus 1 includes a sheet feeding module 5, a printing module 4, a drying module 6, a fixing module 7, a cooling module 8, and a stacking module 9. A large number of recording materials may be stored in the sheet feeding module 5. Each of the recording materials fed one by one from the sheet feeding module 5 is subjected to various processing operations while being conveyed along a conveyance path within each module, and then is finally discharged to the stacking module 9. Each of the sheet feeding module 5, the printing module 4, the drying module 6, the fixing module 7, the cooling module 8, and the stacking module 9 may have separate housings, and these housings may be connected to configure the image forming apparatus 1. Alternatively, all of the above-described modules may be disposed in one housing.

The printing module 4 includes a recording unit for discharging inks to a recording material conveyed from the sheet feeding module 5 to form an image on the recording material. The recording unit includes a total of five recording heads corresponding to four color inks, which are yellow, magenta, cyan, and black, and the reaction liquid. Examples of applicable methods for discharging inks from the recording heads include a method for using a heater element, a method for using a piezoelectric element, a method for using an electrostatic element, and a method for using a Micro Electro Mechanical System (MEMS) element.

The recording material on which an image has been formed by the printing module 4 is conveyed to the drying module 6. In order to enhance the ink fixation to the recording material by the subsequent module, which is fixing module 7, the drying module 6 blows hot air to the recording material to dry the ink-formed image on the recording material.

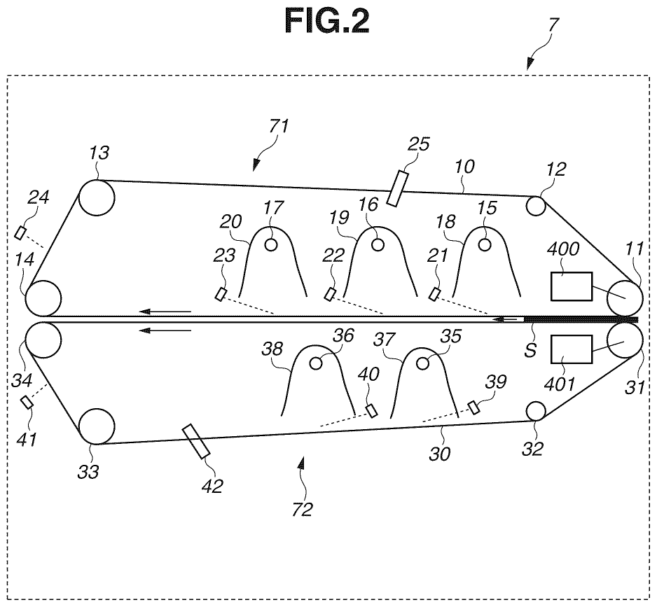

The recording material having the image that has been dried by the drying module 6 is subjected to an operation of the fixing module 7 to fix inks thereon. The fixing module 7 is a fixing apparatus for fixing inks to the recording material conveyed from the drying module 6 while the recording material passes between an upper belt unit 71 and a lower belt unit 72. The fixing module 7 will be described below (see FIG. 2). The cooling module 8 blows cold air to the recording material conveyed from the fixing module 7 by using cooling fans (not illustrated) to cool the recording material heated by the fixing module 7. The cooling fans disposed on both sides of the recording material conveyance path cool both surfaces of the recording material. The cooled recording material is conveyed to the stacking module 9 and then stacked in the stacking module 9.

### <Fixing Module>

The fixing module 7 will be described below with reference to FIG. 2. As illustrated in FIG. 2, the fixing module 7 includes the upper belt unit 71 and the lower belt unit 72. A recording material S is nipped and conveyed by a fixing nip portion formed by an upper belt 10 of the upper belt unit 71 and a lower belt 30 of the lower belt unit 72. In this process, the recording material S is applied with pressure and heat, whereby the ink-formed image is fixed to the recording material S. In the fixing module 7, the belt circumference of the upper belt 10 and the lower belt 30 are secured to be long to reliably fix the ink-formed image to the recording material S.

The upper belt unit 71 as a belt conveyance apparatus includes the upper belt 10, a plurality of rollers 11, 12, 13, and 14 for rotatably supporting and stretching the upper belt 10, upper belt heaters 15, 16, and 17, an upper temperature adjustment sensor 24, and upper heater temperature sensors 21, 22, and 23. The plurality of rollers 11, 12, 13, and 14 for supporting and stretching the upper belt 10 are, specifically, a drive roller 14 for rotatably driving the upper belt 10, a driven roller 12 (second roller) and a driven roller 13 driven by the rotation of the upper belt 10, and a steering roller 11 described below.

Inside the upper belt 10 which is an endless belt, the upper belt heaters 15, 16, and 17 are disposed to heat the upper belt 10. The upper belt heaters 15, 16, and 17 serving as heating units emit, for example, infrared light to heat the upper belt 10. The upper belt heaters 15, 16, and 17 are covered by reflectors 18, 19, and 20, respectively, formed of a material having high heat reflectivity, such as aluminum. The reflectors 18, 19, and 20 are capable of efficiently heating the upper belt 10 by reflecting infrared light emitted from the upper belt heaters 15, 16, and 17, respectively.

The upper temperature adjustment sensor 24 is a temperature sensor for detecting the temperature of the upper belt 10. Temperature control of the above-described upper belt heaters 15, 16, and 17 is performed in such a manner that the temperature of the upper belt 10 detected by the upper temperature adjustment sensor 24 reaches a target temperature. The upper heater temperature sensors 21, 22, and 23 are contactless temperature sensors for detecting the temperature of the upper belt 10 for respective irradiation regions to be irradiated with infrared light emitted from the upper belt heaters 15, 16, and 17, respectively. The upper heater temperature sensors 21, 22, and 23 are provided to monitor the temperature of the irradiation regions heated by the upper belt heaters 15, 16, and 17, respectively, so that if any abnormality or the like occurs and the temperature of the upper belt 10 exceeds the target temperature, power supply to the upper belt heaters 15, 16, and 17 can be turned OFF to stop heating.

The steering roller 11 as a first roller pushes outward the upper belt 10 from the inside to support and stretch the upper belt 10 with a predetermined tension. According to the present embodiment, the steering roller 11 controls the meandering of the upper belt 10 in the width direction (in the rotational axis direction of the steering roller 11) by pivoting with the center portion or one end in the rotational axis direction serving as a pivot point. More specifically, the steering roller 11 has a function of adjusting the deviation of the upper belt 10.

The deviation of the upper belt 10 refers to a phenomenon where the upper belt 10 meanders during rotation and deviates toward one side in the width direction (lateral direction of the belt). If the upper belt 10 deviates excessively toward one side, an edge of the one side of the belt comes into contact with other members, possibly causing damage to the upper belt 10 and other members. Thus, the belt deviation control (also referred to as steering control) in which the steering roller 11 is tilted based on the lateral position of the upper belt 10 is performed to adjust the deviation of the upper belt 10. The fixing module 7 includes a sensor unit 25 and a steering mechanism 400 to perform the belt deviation control for the upper belt 10 using the steering roller 11. The sensor unit 25 is provided to detect lateral positions of the edge of the upper belt 10. The steering mechanism 400 tilts the steering roller 11 in such a manner that the position of the upper belt 10 detected by the sensor unit 25 approximately coincides with a target position. As the steering angle of the steering roller 11 is adjusted, the upper belt 10 during rotation is positioned within a predetermined lateral range while reciprocally moving in the width direction. The sensor unit 25 and the steering mechanism 400 will be described below.

### <Lower Belt Unit>

The lower belt unit 72 may have a configuration similar to the upper belt unit 71. The lower belt unit 72 illustrated in FIG. 2 includes the lower belt 30 as a rotating member, a plurality of rollers 31, 32, 33, and 34 for rotatably supporting and stretching the lower belt 30 in a form of endless belt, lower belt heaters 35 and 36, a lower temperature adjustment sensor 41, and lower heater temperature sensors 39 and 40. The lower belt heaters 35 and 36 are covered by reflectors 37 and 38, respectively, for reflecting infrared light.

The lower temperature adjustment sensor 41 is a temperature sensor for detecting the temperature of the lower belt 30. Temperature control of the lower belt heaters 35 and 36 is performed in such a manner that the temperature of the lower belt 30 detected by the lower temperature adjustment sensor 41 reaches a target temperature. The lower heater temperature sensors 39 and 40 are contactless temperature sensors for detecting the temperature of the lower belt 30 for respective irradiation regions to be irradiated with infrared light emitted from the lower belt heaters 35 and 36, respectively. The lower heater temperature sensors 39 and 40 are provided to monitor the temperature of the irradiation regions heated by the lower belt heaters 35 and 36, respectively, so that if the temperature of the lower belt 30 exceeds the target temperature, power supply to the lower belt heaters 35 and 36 can be turned OFF to stop heating.

One of the plurality of rollers 31, 32, 33, and 34 stretching the lower belt 30 is, specifically, a steering roller 31. The fixing module 7 includes a sensor unit 42 and a steering mechanism 401 to perform the belt deviation control of the lower belt 30 using the steering roller 31. The sensor unit 42 is provided to detect the position of the lower belt 30. The steering mechanism 401 tilts the steering roller 31 in such a manner that the position of the lower belt 30 detected by the sensor unit 42 approximately coincides with the target position.

### <Sensor Unit>

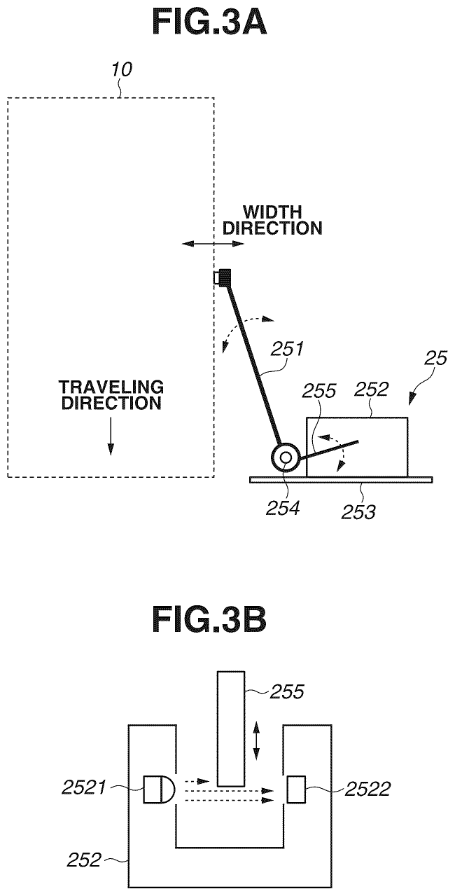

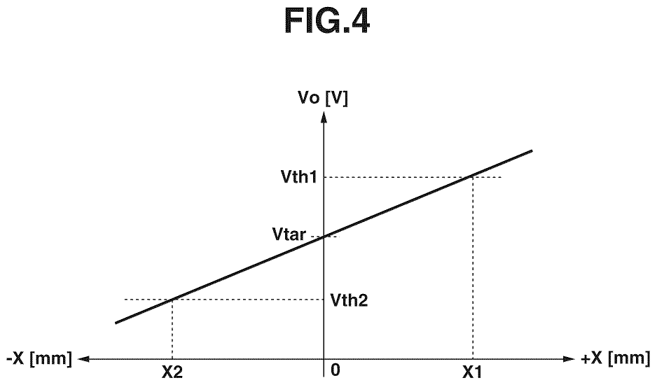

The sensor unit 25 for detecting the position of the upper belt 10 will be described below with reference to FIGS. 3A and 3B and FIG. 4. The sensor unit 42 for detecting the position of the lower belt 30 has a configuration similar to the sensor unit 25, and thus the redundant descriptions will be omitted.

As illustrated in FIG. 3A, the sensor unit 25 as a detection unit includes a flag 251, an optical sensor 252, and a support member 253. The support member 253 supports the flag 251 and the optical sensor 252. The support member 253 is attached to a frame (not illustrated) of the fixing module 7 in such a manner that the sensor unit 25 is disposed at a predetermined position relative to the upper belt 10. The flag 251 comes into contact with an edge of the upper belt 10 and pivots about a supporting axis 254 to follow the movement in the width direction (lateral direction) of the upper belt 10. A light-blocking member 255 having a planar shape is provided on the other end of the flag 251. The light-blocking member 255 is shifted with respect to the optical sensor 252 in accordance with the rotation of the flag 251 about the supporting axis 254 by the lateral movement of the upper belt 10.

The optical sensor 252 is a light transmission type sensor known as a photo-interrupter. As illustrated in FIG. 3B, the optical sensor 252 includes a light emitting element 2521 (e.g., a Light Emitting Diode (LED)) for emitting light, and a light receiving element 2522 for receiving the light emitted from the light emitting element 2521. The above-described light-blocking member 255 is inserted between the light emitting element 2521 and the light receiving element 2522 that are disposed at positions facing each other. The light-blocking member 255 is disposed to partly block the light that is emitted from the light emitting element 2521 and received by the light receiving element 2522. More specifically, the amount of light received by the light receiving element 2522 (received light amount) changes due to the position of the light-blocking member 255 relative to the optical sensor 252. The position of the upper belt 10 is detected based on the magnitude of light received by the light receiving element 2522.

FIG. 4 is a chart illustrating the detection characteristics of the optical sensor 252. Referring to FIG. 4, the horizontal axis represents the amount of deviation X (mm) of the upper belt 10, and the vertical axis represents a detection value Vo (V) of the optical sensor 252. The “+X direction” represents the direction when the upper belt 10 deviates toward one lateral side, and “−X direction” represents the direction when the upper belt 10 deviates to the other lateral side.

As illustrated in FIG. 4, the detection value Vo (V) of the optical sensor 252 changes linearly proportional to the amount of deviation X (millimeter (mm)). This is because the moving amount of the flag 251 is proportional to the amount of deviation of the upper belt 10, and the amount of light received by the light receiving element 2522 changes linearly relative to the moving amount of the flag 251. In the belt deviation control, the steering roller 11 is tilted to move the upper belt 10 in the width direction to the position where the detection value Vo of the optical sensor 252 becomes a detection value “Vtar” corresponding to the amount of deviation “0”. The amount of deviation of the upper belt 10 in this case refers to the amount of deviation between the position of the upper belt 10 detected by the sensor unit 25 and the target position. The amount of deviation “0” indicates a state where the position of the upper belt 10 detected by the sensor unit 25 approximately coincides with the target position. The target position indicates an average value (refers to an average belt position), i.e., the average of edge positions over one rotation of the upper belt 10 detected by the sensor unit 25.

As described above, if the upper belt 10 deviates excessively toward one side, the edge of the one side of the belt comes into contact with other members, possibly causing damage to the upper belt 10 and other members. Thus, when the amount of deviation of the upper belt 10 exceeds a threshold value, the upper belt 10 is stopped to prevent a further deviation of the upper belt 10. Referring to FIG. 4, “X1” represents the threshold value of one lateral side, and “X2” represents the threshold value of the other lateral side. “Vth1” represents the detection value of the optical sensor 252 corresponding to the threshold value “X1” of one side, and “Vth2” represents the detection value of the optical sensor 252 corresponding to the threshold value “X2” of the other side. When the detection value Vo of the optical sensor 252 exceeds “Vth1” or falls below “Vth2”, the upper belt 10 is stopped. This prevents the upper belt 10 from deviating excessively toward either side.

### <Steering Mechanism>

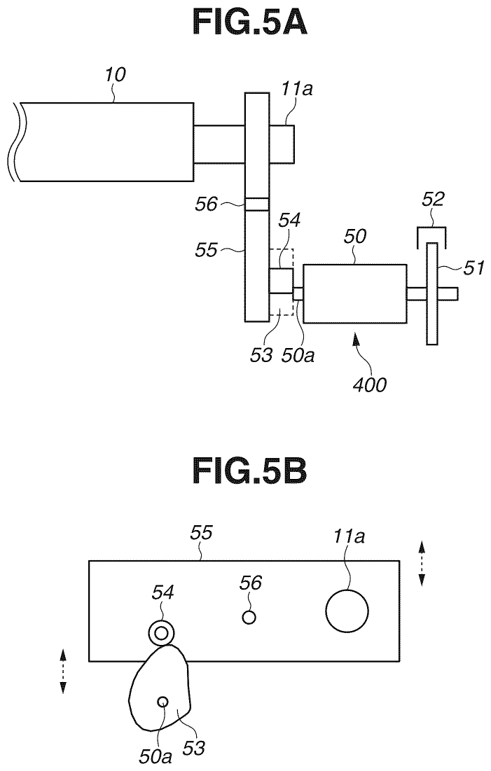

The steering mechanism 400 for use in the belt deviation control for the upper belt 10 will be described below with reference to FIGS. 5A and 5B. The steering mechanism 401 for the belt deviation control for the lower belt 30 has a configuration similar to the steering mechanism 400, and thus the redundant descriptions will be omitted.

As illustrated in FIG. 5A, the steering mechanism 400 includes a steering motor 50, a flag member 51, a home position (HP) sensor 52, a cam member 53, a bearing member 54, and a frame member 55. One end of a shaft member 11a of the steering roller 11 is supported by a bearing (not illustrated) provided in the frame member 55. The frame member 55 is provided with the bearing member 54, and the cam member 53 is brought into contact with the outer circumferential surface of the bearing member 54 via a spring (not illustrated). The cam member 53 is attached to a rotating shaft 50a of the steering motor 50, and rotates in the forward direction or the reverse direction about the rotating shaft 50a with the rotation of the steering motor 50. A stepping motor having a high rotational positioning accuracy of the cam member 53 is used as the steering motor 50. The stepping motor is rotatable in a selected direction, either the forward direction or the reverse direction at a desired rotational speed.

As illustrated in FIG. 5B, when the cam member 53 as a plate cam is rotated by the steering motor 50, the frame member 55 pivots about a rotational axis 56 via the bearing member 54. The other end of the shaft member 11a of the steering roller 11 is fixed to a frame (not illustrated) of the fixing module 7. Thus, when the frame member 55 pivots, one end of the steering roller 11 supported by the frame member 55 moves in the direction opposite to the moving direction of the bearing member 54. This means that the steering roller 11 is tilted. In this way, the steering mechanism 400 rotates the cam member 53 via the steering motor 50 to tilt the steering roller 11, thus performing the belt deviation control of the upper belt 10.

As illustrated in FIG. 5A, the flag member 51 is fixed to the rotating shaft 50a of the steering motor 50. The flag member 51 has a disc shape with a projection, and the HP sensor 52 is disposed in such a manner that the projection of the flag member 51 is detectable. The HP sensor 52 is an optical sensor known as a photo-interrupter. The rotational position of the cam member 53 and the tilting angle of the steering roller 11 when the projection is detected by the HP sensor 52 are predetermined in design. Thus, a position of the steering roller 11 when the projection of the flag member 51 is detected by the HP sensor 52 is defined as a home position, and the tilting angle of the steering roller 11 is adjustable from the home position.

### <Belt Deviation Control>

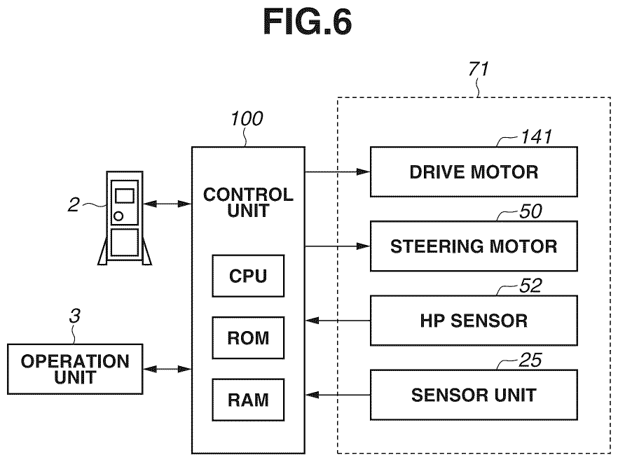

The belt deviation control according to the present embodiment will be described below with reference to FIGS. 6 to 8. The following descriptions provides an example of the belt deviation control for the upper belt 10. The belt deviation control for the lower belt 30 may be similar to the belt deviation control for the upper belt 10, and thus the redundant descriptions will be omitted.

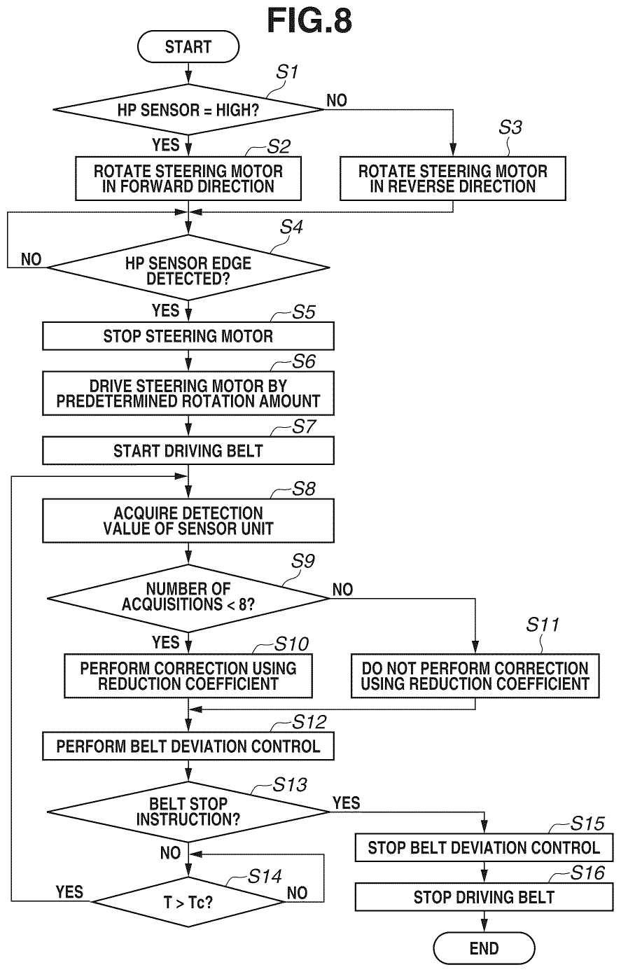

As illustrated in FIG. 6, a control unit 100 controls the upper belt unit 71 as a belt conveyance apparatus. According to the present embodiment, the control unit 100 controls at least the upper belt unit 71 in response to an input of an instruction for starting an “image forming job” from the external apparatus 2 or the operation unit 3. The control unit 100 includes a Central Processing Unit (CPU), a Read Only Memory (ROM), and a Random Access Memory (RAM). According to the present embodiment, the control unit 100 (more specifically the CPU) executes the “belt deviation control processing (program)” described below (see FIG. 8) stored in the ROM to control each unit of the fixing module 7. The RAM stores working data and input data. The CPU executes control with reference to the data stored in the RAM based on the above-described program.

During execution of the “belt deviation control processing”, the control unit 100 acquires the detection value of the HP sensor 52 and the detection value of the sensor unit 25, and controls a drive motor 141 for rotatably driving the drive roller 14 and the steering motor 50 for tilting the steering roller 11 according to these detection values, respectively. The drive motor 141 and the steering motor 50 are controlled by a driver integrated circuit (IC) (not illustrated), and control signals corresponding to the type of the driver IC are output from the CPU.

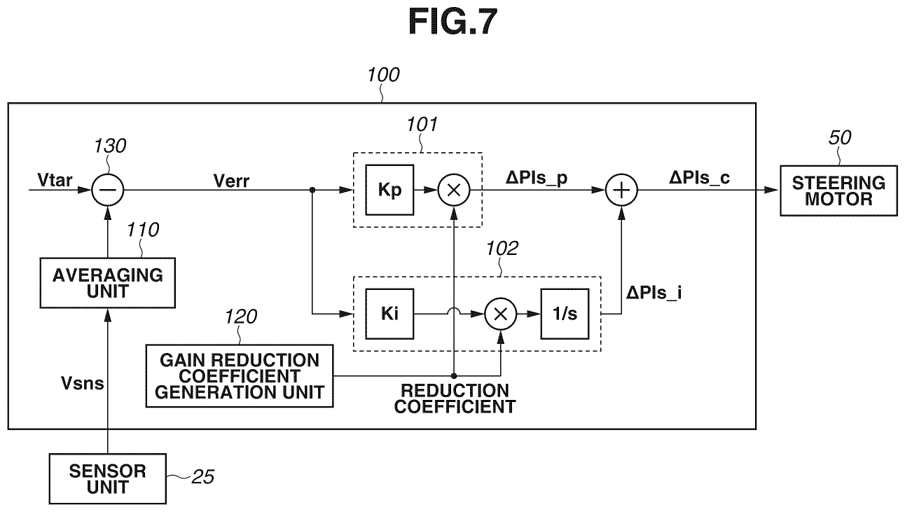

FIG. 7 is a block diagram illustrating control for the steering motor 50. The control unit 100 performs Proportional Integral (PI) control as a feedback control based on the detection value of the sensor unit 25, calculates a steering control amount for operating the steering motor 50, and performs the belt deviation control for the upper belt 10 according to the steering control amount. As illustrated in FIG. 7, the control unit 100 (more specifically, the CPU) includes a proportional control unit 101 and an integral control unit 102 for performing PI control, an averaging unit 110, and a subtraction unit 130.

A detection value “Vsns” of the sensor unit 25 is input to the subtraction unit 130 via the averaging unit 110. The averaging unit 110 averages the detection values “Vsns” sampled at intervals of a detection period “Ts” (seconds) by the sensor unit 25. However, in the present embodiment, the average processing is not performed during the period from when the upper belt 10 starts traveling until samplings for one rotation of the belt are completed but performed after completion of the samplings for one rotation of the belt.

The detection values input from the averaging unit 110 to the subtraction unit 130 are subjected to the difference operation with respect to the target position “Vtar” by the subtraction unit 130. A belt position difference value “Verr” obtained by the difference operation indicates the amount of deviation between the edge position of the upper belt 10 detected by the sensor unit 25 and the target position “Vtar”. The proportional control unit 101 performs a proportional operation for multiplying the belt position difference value “Verr” by a proportional gain Kp and outputs a belt proportional control amount “ΔPls_p” as a result of the operation. The integral control unit 102 performs an integral operation for multiplying the belt position difference value “Verr” by an integral gain Ki, and outputs a belt integral control amount “ΔPls_i” as a result of the operation. The proportional gain Kp and the integral gain Ki that are used in the above-described operations have been pre-adjusted through simulation or a real apparatus.

The belt proportional control amount “ΔPls_p” and the belt integral control amount “ΔPls_i” are added, and a steering control amount “ΔPls_c” is output. The steering control variable “ΔPls_c” is transmitted to the driver IC for controlling the steering motor 50. The driver IC controls the steering motor 50 according to the steering control amount “ΔPls_c”. Thus, the tilting angle of the steering roller 11 is adjusted by the steering motor 50 in such a manner that the edge of the belt is positioned at the target position “Vtar” as closely as possible based on the detection value “Vsns” of the sensor unit 25. As long as the steering control amount “ΔPls_c” can be output, not only PI control but also any feedback control, such as Proportional Integral Derivative (PID) control, Proportional Derivative (PD) control, Proportional (P) control, or the like, is applicable.

After completion of one rotation from the timing when the upper belt 10 starts traveling, the control unit 100 matches the detection period Ts (seconds) of the sensor unit 25 with a control period Tc (seconds), which is the period for controlling the tilting angle of the steering roller 11. The detection period Ts of the sensor unit 25 is “1/N” times the one rotation period Tb (seconds) of the upper belt 10. The reason for this will be described below. The lateral dimension of the upper belt 10 includes a dimensional tolerance in the manufacture of belts. The lateral dimensional tolerance may vary along the traveling direction of the upper belt 10. Therefore, the detection value of the sensor unit 25 for detecting the position of edge of the belt includes repetitive variation components (referred to as edge profile components) for one rotation of the belt. To eliminate the edge profile components, the control unit 100 sets the detection period Ts of the sensor unit 25 to divide one rotation of the belt at equal intervals, and instructs the averaging unit 110 to average a plurality of detection values of the sensor unit 25 obtained in samplings for one rotation of the belt. In the present embodiment, the control unit 100 divides one rotation of the belt into eight by using the division number “8”. If the division number N is set to be small, it becomes difficult to eliminate the edge profile components, and if the division number N is set to be large, the load on the CPU is increased. Thus, the control unit 100 sets the division number N in consideration of these facts.

When one rotation speed of the upper belt 10 is “Vb” (mm/second) and the belt circumferential length is “Lb” (mm), because the belt one rotation period Tb (seconds) is derived as “Lb/Vb”, and thus the detection period Ts of the sensor unit 25 is set to “Lb/Vb/8”. In a case where the detection values of the sensor unit 25 are sampled at intervals of the detection period Ts, the averaging unit 110 performs the average processing based on eight detection values.

However, during the time period from when the upper belt 10 starts traveling until the belt rotates one round, depending on sampling at intervals of the detection period Ts, the control unit 100 cannot acquire the detection values of the sensor unit 25. More specifically, the detection value output from the averaging unit 110 includes the edge profile components, which result in difficulty in detecting the correct amount of belt deviation. For this reason, even after application of the PI control, the upper belt 10 does not become stable and largely meanders, possibly deviating all the way to one side.

In view of the above-described issue, in the present embodiment, the control unit 100 does not perform the average processing during the time period from when the upper belt 10 starts traveling until the belt rotates one round, and corrects the steering control amount “ΔPls_c” obtained through PI control, to stabilize the behavior of the upper belt 10. This control will be described below.

As illustrated in FIG. 7, the control unit 100 includes a gain reduction coefficient generation unit 120. The gain reduction coefficient generation unit 120 outputs the “reduction coefficient” illustrated in Table 1 below to the proportional control unit 101 and the integral control unit 102 for each of the plurality of samplings for one rotation of the belt during the time period from when the upper belt 10 starts traveling until samplings for one rotation of the belt are completed. The proportional control unit 101 and the integral control unit 102 output the belt proportional control amount “ΔPls_p” and the belt integral control amount “ΔPls_i”, respectively, which have been corrected based on the “reduction coefficient”.

Table 1 illustrates the reduction coefficient output by the gain reduction coefficient generation unit 120. Table 1 is prestored in the ROM or the like of the control unit 100. The number of detections indicates the sampling number (first sampling, second sampling, and so on) of the plurality of samplings of belt positions detected by the sensor unit 25 during the time period from when the upper belt 10 starts traveling until the belt rotates one round. According to the present embodiment, during the time period from when the upper belt 10 starts traveling until the belt rotates one round, the “control period Tc” for controlling the tilting angle of the steering roller 11 is set for each of the plurality of timings derived by equally dividing the circumferential length of the upper belt 10, and belt positions are sampled based on this setting.

TABLE 1

| Number of Detections | 1 | 2 | 3 | 4 | 5 | 6 | 7 |
|---|---|---|---|---|---|---|---|
| Coefficient | 1/8 | 2/8 | 3/8 | 4/8 | 5/8 | 6/8 | 7/8 |

The gain reduction coefficient generation unit 120 outputs the “reduction coefficient” (control coefficient) smaller than “1” while the number of detections has not reached the value for one rotation of the belt (first to seventh samplings). The gain reduction coefficient generation unit 120 outputs the relatively small “reduction coefficient” for the small number of detections, and outputs the larger “reduction coefficient” for the number of detections closer to 8 (eighth sampling) corresponding to one rotation of the belt. More specifically, the gain reduction coefficient generation unit 120 outputs a first control coefficient at a first timing and outputs a second control coefficient larger than the first control coefficient at a second timing later than the first timing. This is because, by correcting the original steering control amount calculated based on the detection values of the sensor unit 25 according to the “reduction coefficient”, the control unit 100 enables gradually decreasing the meandering of the upper belt 10 to bring the meandering closer to the converged state, as the number of detections (number of samplings) increases.

As described above, in the present embodiment, the control unit 100 controls the steering mechanism 400 according to the corrected steering control amount (second tilting angle), smaller than the original steering control amount (first tilting angle), which has been obtained by correcting the original steering control amount calculated based on the detection values of the sensor unit 25 according to the reduction coefficient smaller than “1” while the number of detections from when the time when the upper belt 10 starts traveling is small. This reduces the change of the tilting angle of the steering roller 11. Consequently, according to the present embodiment, the meandering of the upper belt 10 is prevented, and the traveling of the belt during the time period from when the upper belt 10 starts traveling until the belt rotates one round during which the edge profile components cannot be eliminated conventionally is stabilized.

### <Belt Deviation Control Processing>

The “belt deviation control processing” according to the present embodiment will be described below with reference to FIG. 8 in addition to FIGS. 6 and 7. FIG. 8 is a flowchart illustrating the belt deviation control processing. The belt deviation control processing illustrated in FIG. 8 is started by the control unit 100 (more specifically, the CPU) when the fixing module 7 is activated. The fixing module 7 is activated, for example, when the image forming apparatus 1 is activated and when the apparatus resumes from the sleep mode as a power-saving standby state.

Referring to FIG. 8, in step S1, the control unit 100 determines whether the detection value of the HP sensor 52 is “High”. In a case where the detection value of the HP sensor 52 is “High” (YES in step S1), the processing proceeds to step S2. In step S2, the control unit 100 rotates the steering motor 50 in the forward direction to tilt the steering roller 11 in either the upward or the downward direction. In a case where the detection value of the HP sensor 52 is not “High” but “Low” (NO in step S1), the processing proceeds to step S3. In step S3, the control unit 100 rotates the steering motor 50 in the reverse direction to tilt in the direction opposite to the above-described direction.

In a case where neither edge of the upper belt 10 is detected by the HP sensor 52 (NO in step S4), the control unit 100 keeps rotating the steering motor 50. When the detection value of the HP sensor 52 changes from “High” to “Low” or from “Low” to “High”, the control unit 100 determines that an edge of the upper belt 10 is detected by the HP sensor 52. In a case where the edge of the upper belt 10 is detected (YES in step S4), the processing proceeds to step S5. In step S5, the control unit 100 stops the steering motor 50. Thus, the steering roller 11 is positioned at the home position from which the tilting angle of the steering roller 11 is to be adjusted.

In step S6, the control unit 100 drives the steering motor 50 by a predetermined rotation amount to tilt the steering roller 11 to the tilting angle corresponding to the neutral point, where no deviation of the upper belt 10 occurs, as the nominal design value from the home position. Since the steering motor 50 is a stepping motor, the driving by the predetermined rotation amount can be controlled based on the number of pulses of a clock signal output to the driver IC (not illustrated). After tilting the steering roller 11 to the tilting angle corresponding to the neutral point, then in step S7, the control unit 100 rotates the drive motor 141 to start traveling of the upper belt 10. In step S8, the control unit 100 acquires the detection value of the sensor unit 25.

In step S9, the control unit 100 determines whether the number of detections of the detection values of the sensor unit 25 is less than a predetermined value (e.g., 8). In a case where the number of detections of the detection value of the sensor unit 25 is less than the predetermined value, i.e., in a case where the number of samplings of belt positions by the sensor unit 25 is less than the predetermined value (YES in step S9), the processing proceeds to step S10. In step S10, the control unit 100 instructs the gain reduction coefficient generation unit 120 to output the “reduction coefficient”. More specifically, during the time period from when the upper belt 10 starts traveling until the belt rotates one round during which the number of samplings of belt positions by the sensor unit 25 is less than the predetermined value, the control unit 100 corrects the original steering control amount calculated based on the above-described detection value of the sensor unit 25 based on the “reduction coefficient”, and in step S12, performs the belt deviation control.

In a case where the number of detections of the detection value of the sensor unit 25 is equal to or larger than the predetermined value, i.e., in a case where the number of samplings of belt positions is more than the predetermined value (NO in step S9), the processing proceeds to step S11. In step S11, the control unit 100 instructs the gain reduction coefficient generation unit 120 not to output the “reduction coefficient”. In this case, in step S12, the control unit 100 performs the belt deviation control without correcting the original steering control amount calculated based on the above-described detection value of the sensor unit 25.

In step S13, the control unit 100 determines whether a belt stop instruction is acquired from the external apparatus 2 or the operation unit 3. In a case where the belt stop instruction is acquired (YES in step S13), the processing proceeds to step S15. In step S15, the control unit 100 stops the belt deviation control by the steering motor 50. In step S16, the control unit 100 stops the rotation of the drive motor 141 to stop the upper belt 10.

In a case where the belt stop instruction is not acquired (NO in step S13), the processing proceeds to step S14. In step S14, the control unit 100 determines whether the time period corresponding to the control period Tc for controlling the tilting angle of the steering roller 11 has elapsed from the timing of sampling a belt position, based on the time counted from the time when the upper belt 10 starts traveling. In a case where the time period corresponding to the control period Tc has elapsed (YES in step S14), the processing returns to step S8. Then, the control unit 100 continues sampling the belt position using the sensor unit 25. As described above, during the time period from when the upper belt 10 starts traveling until the belt rotates one round, the “control period Tc” is set to the timing with which the length of the upper belt 10 is equally divided in the traveling direction. After completion of one rotation from the timing when the upper belt 10 starts traveling, the “control period Tc” is set to the detection period Ts of the sensor unit 25.

As described above, according to the present embodiment, during the time period from when the upper belt 10 starts traveling until the belt rotates one round, the meandering of the upper belt 10 is suppressed by reducing the feedback gain of a control system of the belt deviation control. After completion of one rotation from the timing when the upper belt 10 starts traveling, the control unit 100 controls the steering mechanism 400 according to the steering control amount obtained based on positions of the upper belt 10 detected by the sensor unit 25. In contrast, during the time period from when the upper belt 10 starts traveling until the belt rotates one round, the control unit 100 corrects the original steering control amount obtained based on positions of the upper belt 10 detected by the sensor unit 25, according to the reduction coefficient (feedback gain) smaller than “1”. Then, the control unit 100 controls the steering mechanism 400 according to the corrected steering control amount smaller than the original steering control amount. With this configuration, during the time period from when the upper belt 10 starts traveling until the belt rotates one round, it is possible to realize the belt deviation control that gradually reduces the meandering of the upper belt 10 and brings the upper belt 10 closer to the converged state in comparison with conventional control.

### OTHER EMBODIMENTS

The belt conveyance apparatus according to the present embodiment is not limited to applying the belt deviation control to the upper belt 10 and the lower belt 30 in the fixing module 7. For example, the belt conveyance apparatus may also be applied to the belt deviation control for a belt for conveying a recording material in the printing module 4, the drying module 6, the cooling module 8, and other modules. Alternatively, the belt conveyance apparatus may be applied to the belt deviation control for an intermediate transfer belt used in an electrophotographic image forming apparatus.

According to the present disclosure, even during the time period from when the belt starts traveling from a stop state until the belt rotates one round, the meandering of a belt can be suppressed through belt deviation control.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2024-227295, filed Dec. 24, 2024, which is hereby incorporated by reference herein in its entirety.

What is claimed is:

1. A belt conveyance apparatus comprising:
a belt in a form of an endless belt;
a first roller configured to support and stretch the belt;
a second roller configured to support and stretch the belt together with the first roller;
a steering mechanism configured to tilt the first roller, which rotates, relative to the second roller, to cause the belt to move reciprocally in a rotational axis direction of the first roller;
a detection unit configured to detect an edge of the belt in the rotational axis direction, the detection unit sampling a plurality of points of the edge of the belt during a time period from when the belt starts traveling until the belt rotates one round; and
a control unit configured to control the steering mechanism according to a steering control amount obtained by a correction based on the sampling of the edge of the belt detected by the detection unit,
wherein, during the time period from when the belt starts traveling until the belt rotates one round, the control unit controls the steering mechanism based on a first steering control amount, and
wherein, after completion of one rotation of the belt, the control unit controls the steering mechanism based on a second steering control amount larger than the first steering control amount.

2. The belt conveyance apparatus according to claim 1, wherein, during the time period from when the belt starts traveling until the belt rotates one round, the control unit samples the edge of the belt at each of a plurality of timings derived by equally dividing a circumferential length of the belt.

3. The belt conveyance apparatus according to claim 2, wherein the second steering control amount is a value obtained by correcting the edge of the belt detected by the detection unit, based on a first tilting angle obtained by the sampling for one rotation of the belt.

4. The belt conveyance apparatus according to claim 3, wherein, during the time period from when the belt starts traveling until the belt rotates one round, the control unit corrects the first tilting angle based on the control coefficient when the proportional operation and the integral operation are performed.

5. The belt conveyance apparatus according to claim 3, wherein, after completion of one rotation from the timing when the belt starts traveling, the control unit controls the steering mechanism based on the first tilting angle obtained based on a position of the belt.

6. The belt conveyance apparatus according to claim 2, wherein the first steering control amount is a value obtained by correcting the edge of the belt detected by the detection unit, based on a second tilting angle obtained according to a control coefficient smaller than 1 relative to the tilting angle obtained by the detection unit.

7. The belt conveyance apparatus according to claim 1, wherein the control unit applies a proportional operation and an integral operation to a difference value between a position of the edge of the belt and a target position, and obtains a tilting angle of the first roller based on a sum of results of these operations.

8. A fixing apparatus for fixing a toner image formed on a recording material to the recording material, the fixing apparatus comprising:
the belt conveyance apparatus according to claim 1;
a heating unit configured to heat a belt of the belt conveyance apparatus; and
a rotating member, that is in contact with an outer circumferential surface of the belt, configured to form a fixing nip portion for applying heat and pressure to the recording material while nipping and conveying the recording material, to fix the toner image to the recording material.

9. The fixing apparatus according to claim 8, wherein the rotating member is an endless belt.
